(19) United States
(12) Patent Application Publication
(10) Pub. No.: US 2012/0197785 A1
(43) Pub. Date: Aug. 2, 2012

(54) APPARATUS AND METHOD FOR MANAGEMENT OF INTELLECTUAL PROPERTY RIGHTS

(76) Inventors: Keith Cooper, Jersey City, NJ (US); Gavin Robertson, Glasgow (GB); Gordon Rintoul, Kent (GB)

(21) Appl. No.: 13/362,886

(22) Filed: Jan. 31, 2012

Related U.S. Application Data
(60) Provisional application No. 61/437,917, filed on Jan. 31, 2011.

(51) Int. Cl. G06Q 50/18; G06Q 40/02

(52) U.S. Cl. 705/39; 705/310

(57) ABSTRACT

A computer program product for managing intellectual property rights comprising a user interface and a database. The user interface may prompt a user for input of data relating to the intellectual property rights. The database may store data related to the intellectual property rights and may comprise a registration interface, a contracts interface, a social networking interface and a royalty management interface. The user may be prompted with an identification of a desire to exploit the intellectual property or an indication that the intellectual property has been exploited. The computer program product may use a processor that executes instructions to prompt the user for data, to store data, to provide access to the social network, to manage royalties, to indicate the desire to exploit the intellectual property and to indicate the intellectual property has been exploited.

### RELATED APPLICATIONS

The present application claims the benefit of U.S. Provisional Patent Application Ser. No. 61/437,917 titled APPARATUS AND METHOD FOR MANAGEMENT OF INTELLECTUAL PROPERTY RIGHTS filed by the inventor of the present invention on Jan. 31, 2011, the entire contents of which are incorporated herein by reference.

### FIELD OF THE INVENTION

This invention relates to the field of intellectual property and, more specifically, to an apparatus and a method for management of intellectual property rights.

### BACKGROUND OF THE INVENTION

The current means of managing various intellectual property rights is through the use of multiple agents. Many times, creators of intellectual property may attempt to seek to manage intellectual property protection without assistance from an intellectual property professional. In order to do this, a creator must have a good understanding of what to do and how to do it. A lack of such knowledge may result in either loss of the creator's intellectual property rights, or a requirement for the creator to sign multiple sub-contracting deals to ensure proper administration of their intellectual property rights.

Even agents of intellectual property rights, such as, for example, publishers, can find international exploitation of intellectual property rights in all types of usage, including new types being constantly brought to market, extremely hard. At present, there exist many different options that must be considered when managing intellectual property rights. These options may include, for example, the creation process, registration or fixation of rights, reproduction of rights, performance of rights, aggregation of rights, adaptation of rights, approvals, marketing of rights, promotion of rights, assignment/sale of rights, licensing of rights, monitoring/identification of unlicensed exploitations, administration of royalty data, and administration of royalty financials. Even within many of these areas there are additional factors such as legal contracts and a communication and audit trail that is necessary to ensure compliance.

Many systems have been introduced to attempt to assist creators of intellectual property in managing their intellectual property rights. For example, U.S. Pat. No. 7,249,029 to Martin et al. discloses a method for using a computerized administration system to administer licensing of use of copyrighted material. The method includes an administrator storing, in a database of the system, information regarding copyright material available for license and being supplied by a plurality of licensors. The method also includes a plurality of Applicants for licenses using the copyrighted material using a licensee computer apparatus to access and interrogate the database of the computerized administration system to determine what license is required for each copyrighted material. Unfortunately, however, this is only one aspect of what is necessary in the current state of the market. In other words, this method only provides a method for storing copyrighted material in a searchable database that allows prospective licensees to view licenses that may be available using a specialized computer.

U.S. Pat. No. 5,765,152 to Erickson discloses a system and method for managing copyrighted electronic media. The system allows users to connect to a server to provide online licensing and copyright management for media. The system also allows for data to be transferred and licenses to be transacted on line. Accordingly, this system is also limited to the licensing aspect, which is one small issue in the vast world of intellectual property rights management.

Accordingly, there exists a need for a better intellectual property rights management system.

### SUMMARY OF THE INVENTION

There exists a need to have a system and method that enables a creator of intellectual property to manage all aspects of their creative rights and royalties through a single portal or interface. Furthermore, as an ever increasing number of new types of intellectual property rights exploitation come to market through technological advances, the trend is for the volume of use to increase as the value of each use decreases. This creates a core need for a system to advantageously manage rights in such a way that small value exploitations become viable. The speed to market is also critical so there is a need for intellectual property rights management to have an integral link to social networking to help identify trends, rights and talent. For example, ten years ago it could take a creator several years to go through the launch process whereas it could now take just several weeks and in the future may take only several minutes or may be almost immediate.

With the above in mind, the present invention is directed to a computer program product for managing intellectual property rights. The computer program product may include a user interface that prompts a user for input of data relating to the intellectual property rights to be managed, and a database to store the data relating to the intellectual property rights to be managed. The database may include a registration interface to prompt the user for input of data relating to the intellectual property rights to be managed for storage on the database. The intellectual property for which the intellectual property rights are to be managed is uploadable using the registration interface. The database may also include a contracts interface to prompt the user for input of data regarding contracts related to the intellectual property rights to be managed for storage on the database. The contracts may be uploadable using the contracts interface.

A social networking interface which prompts the user for input of data relating to the intellectual property rights may also be included in the database. The social networking interface may provide access to members of a social network to at least a part of the intellectual property. The database may still further include a royalty management interface that permits the user to manage royalties relating to the intellectual property.

The computer program product may prompt the user with an indication of a desire to exploit the intellectual property from another user, or an indication that the intellectual property has been exploited by another user using the user interface. Further, the computer program product may use a processor that executes instructions to prompt the user for data, to store data, to provide access to the social network, to manage royalties, to indicate the desire to exploit the intellectual property and to indicate the intellectual property has been exploited.

Exploitation of the intellectual property may be selected from the group consisting of broadcast of the intellectual property, performance of the intellectual property, synchronization of the intellectual property, and reproduction of the intellectual property in whole or in part. The contracts stored on the database may include a plurality of form agreements relating to the exploitation of the intellectual property rights that are accessible, searchable, customizable, or usable by the user using the user interface. The plurality of form agreements may be selected from the group consisting of a licensing agreement, a collaboration agreement, a synchronization agreement, a public performance agreement, and a reproduction agreement. A contract entered into by the user may also advantageously be uploadable to the contracts database using the user interface.

An application for registration of the intellectual property may be automatically filed with an appropriate authority upon uploading the intellectual property to the registration interface. The registration interface may prompt the user for entry of information relating to whether or not the intellectual property has been registered by an appropriate authority. Entry of information indicating that the intellectual property has not been registered may result in the registration interface prompting the user for an indication of whether or not the user desires the intellectual property to be registered. An indication that the user desires the intellectual property to be registered may result in the registration interface prompting the user for information necessary to file an application for registration of the intellectual property with the appropriate authority. The registration interface may also advantageously monitor a registration for the intellectual property and prompts the user for information necessary to maintain the registration. This feature of the present invention advantageously allows for the intellectual property rights to be readily maintained as necessary so that exploitation thereof can continue to be managed.

The user, after inputting the data using the registration interface, may be defined as a registered user. The registered user may thereafter be assigned an account that is stored in the database. Royalties that may be collected from exploitation of the intellectual property may automatically be deposited into the account. Fees associated with management of the intellectual property may be automatically debited from the account of the registered user, and funds in the account of the registered user may be automatically depositable into an account external to the computer program product as designated by the registered user. This feature of the present invention advantageously allow for financial transactions associated with management of the intellectual property to be carried out in a seamless fashion.

A method aspect of the present invention is for managing intellectual property rights using a computer program product. The method may include entering data relating to the intellectual property rights to be managed using the user interface responsive to a prompt. The method may further include storing the data on the database. The step of storing the data on the database may include entering data using a registration interface responsive to a prompt to the user for input of the data relating to the intellectual property rights to be managed. The intellectual property may be uploadable using the registration interface. Storing the data may also include entering data using a contracts interface responsive to a prompt for input of the data regarding contracts related to the intellectual property rights. The contracts related to the intellectual property may be uploadable using the contracts interface.

The step of storing the data may further include entering data using a social networking interface responsive to a prompt to the user. The social networking interface may advantageously provide access to members of a social network to at least a part of the intellectual property. The method may still further include entering data using a royalty management interface responsive to a prompt to the user. The royalty management interface may permit the user to manage royalties relating to the intellectual property. The method may also include responding to a prompt from the user interface that indicates a desire to exploit the intellectual property from another user or that indicates that the intellectual property has been exploited by another user.

### BRIEF DESCRIPTION OF THE DRAWINGS

FIG. 1 is a schematic block diagram of a computer program product according to an embodiment of the present invention for managing intellectual property rights.

FIG. 2 is a block diagram of a typical computer system used to run the computer program product illustrated in FIG. 1.

FIGS. 3-13 are flowcharts illustrating method aspects of the present invention directed to operating the computer program product illustrated in FIG. 1.

FIGS. 14-15 are exemplary screen shots of the computer program product according to an embodiment of the present invention, provided for exemplary purposes and not meant to be limiting in any way.

FIGS. 16-17 are additional flowcharts illustrating method aspects of the present invention directed to operating the computer program product illustrated in FIG.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Those of ordinary skill in the art will realize that the following embodiments of the present invention are only illustrative and are not intended to be limiting in any way. Other embodiments of the present invention will readily suggest themselves to such skilled persons having the benefit of this disclosure. Throughout this disclosure, the present invention may be referred to as a computer program product, a computer program, a product, a system, a tool, and a method. Those skilled in the art will appreciate that this terminology does not affect the scope of the invention as outlined in the claims appended herewith. Likewise, throughout this disclosure, the present invention may be referred to as relating to musical works, musical creations or musical compositions. Those skilled in the art will appreciate that this terminology is only illustrative and does not affect the scope of the invention as outlined in the claims appended herewith. For instance, the present invention may just as easily relate to the management of trademarks, patents or works other than musical compositions that are suitable for copyright protection, such as books, plays, or visual works.

The present invention relates to a process that allows creators of musical works to administer their copyrights directly and through agents. The creator of works that may be entitled to intellectual property rights can manage agreements, register their interest in a musical creation(s), however small, and have that interest, in turn, fully managed. The system also allows creators to connect and interact with other members of the system for business networking, collaboration in new creations, or for any other purpose, as understood by those skilled in the art. The core components of the system architecture, according to an embodiment of the present invention, are a registration and administration interface, creation databases (including sub-copyrights where a creation is used within another), a contracts database to determine licenses and usage, a business user interface, a social network interface, royalty management/monitoring, application interfaces to multiple third parties, and feedback tools for negotiations, permissions and approvals. This architecture allows the creator to control their intellectual property rights in their creation(s) from the very start of the creative process and onward to any ending point that the creator may desire, e.g., through to contracts, permissions and royalties, all while connecting with third parties through business and social networks. The system and method according to the present invention provide users with the ability to use third party tools and registrations that are readily accessible through the system. Accordingly, the system and method according to the present invention advantageously become a part of a much larger network by integrating accessibility to such third party tools. It is therefore understood that the system according to the present invention is not meant to be limited to a closed system. Instead, the system according to the present invention advantageously enables connections of an intellectual property rights owner to a wider, evolving business and creative world.

Additional features of the present invention are now described in greater detail. More specifically, the invention may be provided by a system and/or method with an associated computer process. The components of the system, as described above, may allow a creator to access the system at a point of creation or directly from the tools of their creation. The system according to an embodiment of the present invention also provides the creator with means of achieving registration of the works that have been created and that may be entitled to intellectual property rights. The system also stores the works that have been created by the creator in a database and displays the creative rights associated with the works, thereby advantageously allowing for a business user to access the creative works using a user interface. This advantageously allows for direct licensing, as well as agency licensing, and may include contract negotiation tools and legal integration tools.

The system according to an embodiment of the present invention also provides full feed-back for monitoring and collecting royalties associated with licensing of the intellectual property rights with accurate data for auditing and full integration with business and social networks for business marketing and creative processes. Furthermore there is a component of the system and method according to an embodiment of the present invention that enables any charging mechanism to be used including flat-fees, upfront royalty advances or on-going deductions from royalty streams or any combination thereof as will be readily understood by those skilled in the art. The present invention can enable a creator to act as their own rights administrator or fully control the decisions being made by any licensed rights administrator. This can generally be known in the art as the ability to “white label,” or brand i.e., become one's own publisher. This may, for example, include off-site tools and the ability to control the intellectual property rights locally.

As will be discussed in greater detail herein, the present invention may also include many other features. For example, an embodiment of the present invention may allow a user to automatically register an intellectual property right with multiple agencies in multiple territories and for multiple types of exploitations. The present invention may also enable creators of works that may be entitled to intellectual property rights to collaborate through amalgamation of existing creations, or new ones, and agree as to rights metadata as part of that process. This process may include virtual, multi-lingual environments which, in turn, may include co-writers, sampling, multi-media and third party collaboration tools. The present invention may still further enable a potential licensee to seek approval for various intellectual property rights using a plurality of tools including text, email, messaging, microblogging or new communication methods that may be introduced that enable approvals to be administered.

Those skilled in the art will appreciate that communication with a creator of a work that may be entitled to intellectual property rights is not always for financial negotiation. Instead, such communication may be for usage approval. Thus the method according to an embodiment of the present invention preferably enables contact between all appropriate parties with all appropriate questions relating to usage approval to ensure deal or usage closure or termination, as the case may have it.

The system and method according to an embodiment of the present invention further advantageously enables performers to automatically register their performances of creations that may be entitled to intellectual property rights with appropriate collective bodies to ensure proper payments. This can sometimes be achieved through auto identification of the creations using analysis tools. For example, a performer's set list may be automatically registered with collection societies, possibly using an audio identification process to identify the songs.

The system and method according to an embodiment of the present invention may also advantageously provide a user with legal templates containing direct links for additions, iterations, negotiations and sign-off with single or multiple parties. This can advantageously allow creators of works that may be entitled to intellectual property rights to readily enter into various licensing agreements, for example, or engage in other simple types of contractual matters without the need, and expense, of an attorney or solicitor. The system and method according to an embodiment of the present invention may still further advantageously provide a user with an ability to automatically include rights into a licensing deal according to a user-defined criteria that can be changed at any time by any party that has approval to do so. To be provided permission to make any such changes, a user may simply adjust a setting on their account that can be equated to a privacy setting, for example, on many social networking sites. In other words, the user is provided with the ability to readily limit access to and provide permissions to those who can make such changes. This feature would preferably provide a user with a full option control desk to enable a user to say how and when an intellectual property right can be licensed and when (and whether) they want to be involved at the permission or negotiation level.

The system and method according to an embodiment of the present invention may further advantageously enable automated reproduction, manufacture or performance of works that may be protected by intellectual property rights that have been compiled in the system, i.e., within one of the databases of the system. This could include, for example, versioning for specific language, territorial and/or exploitation types such as a German manuscript or super-high quality audio/visual. This feature advantageously could, for example, be used when a user uploads new audio to a database of the system. Upon uploading the audio to the database, the user may automatically be provided with the musical score associated with the audio file or a translation of the lyrics/libretto.

The system and method according to an embodiment of the present invention may also advantageously automatically compile, possibly using third party application interfaces or database searches, additional deep level metadata including audio-visual analysis, relational activities and relational interested parties. Accordingly, new audio, for example, that is uploaded to a database of the system may have basic metadata completed, and the system may then add as much as possible from music interrogation such as beats per minute or related artists and social metadata.

The system and method according to an embodiment of the present invention still further advantageously enables new creations to be announced on multiple social network pages, broadcast systems or any other media, as understood by those skilled in the art, as part of the creative registration process. This may include a first performance of the creation with a timestamp and notification email sent to prove first performance for copyright ownership. This may also include an archive copy of such performance with a timestamp, as well as the ability to send, for review and feedback, i.e. feedback from the press, if the creation includes other creations, e.g. sample or adaptation of other creations. This may then trigger an automatic clearance process. The automatic clearance process may include automatically identifying that a creation has been sampled which, in turn, may include auto-searching third party systems to identify the appropriate third party creators and/or agents. In other words, the computer program product and associated methods according to embodiments of the present invention may automatically determine if intellectual property that is to be managed has been exploited and may also automatically inform the intellectual property owner/author/creator of such exploitation. Thereafter, the associated third party creators and/or agents, may be brought together into the clearance process. When dealing with the creation of a neighboring right, such as a recording, the allocation proceeds that may be realized by exploitation of the intellectual property rights may be assisted with an automated process. The automated process may include using feeds from the recording desk with analysis of time that has been spent, or importance of contribution using musical analysis. Similarly, the system and method according to the present invention can advantageously provide links, or other connections, to music specialists, or other specialists in the field in which the intellectual property rights are to be managed, that can be helpful to resolve any number of issues such as, for example, resolving disputes.

In cases where there are co-creators of the work to be protected by intellectual property rights, the method may include the ability to have the co-creators approve an automated co-writer(s) share approval process. Co-writers need not be first party users of the system and method according to the present invention, i.e., not members or registered users, as may be understood by those skilled in the art. When a new creation is completed, an appropriate feed may enable merchandise to be automatically manufactured. This may, for example, include predetermined instructions. In cases where there may be a business need for a creation, a potential licensee could create a set of requirements with an automated suggestion of appropriate creations. This may include picture, sounds and words. A business user may become part of an end-to-end process that includes the original creator and all relevant interim parties. In some instances, the business may become a part owner of the intellectual property rights, depending, of course, on the contribution of the business to the work of art that is to be protected by the intellectual property rights. A user may be any party who could be seen to be part of the wider network.

The system and method according to an embodiment of the present invention may also enable the users to manage intellectual property rights as if the users were international businesses and, accordingly, allow the users to compete with such large businesses. In other words, the computer program product, system and methods according to the present invention advantageously provides the users with the same resources that would normally only be available to large international businesses. The computer program product, system and methods according to an embodiment of the present invention may provide the creator of the intellectual property with access to many third party tools that can assist with the creation process. This may include, for example, tools to find creation partners, or a number of other tools that may be useful in the creation and exploitation of the intellectual property, as understood by those skilled in the art. As used herein, creation can include, but is not limited to, composing, writing, and embodying new works. Collaboration, as used herein, can include, but is not limited to, creating together, with other members or non-members, new works in any permutation. Creation may be accomplished by a member or collaborators using tools within the system, or using tools added or provided by third parties, to allow recording or writing together in a virtual recording studio/creation environment available through the system to members and their collaborators. Creation may be achieved in real time with multiple parties contributing simultaneously, or can be achieved over time with each contributor saving their contribution sequentially, building upon the contributions of others, or any combination of the two. The system may time-stamp each contribution from each contributor and store such information on a database.

The computer program product, system and method according to an embodiment of the present invention may also provide the user with the ability to identify, receive and/or pay royalties in real time. This ability may include a real-time calculation of royalties due, or potentially due based on various conditions such as market trends, previous payments, earnings in similar territories, chart positions, projected chart positions, and may advantageously provide a real-time payment to be made to the creator. The system and method according to the present invention contemplates that this payment can possibly be made in the form of an advance. This may include a direct payment from the licensee in real time or soon thereafter, i.e., one hour after, or on a daily basis, for example. As will be described in greater detail below, additional advantageous features relating to payment collection and distribution are provided by embodiments of the present invention.

The computer program product, system and method according to the present invention may still further include graphics for projected royalties based on ongoing data feeds. These graphics could be displayed on a user interface upon analysis of various factors, and could show potential earnings based upon certain trends, and making certain assumptions with those trends should the trends continue based on live data and related information. This advantageously provides the user with a simplified system for conducting an analysis of royalties.

The computer program product, system and method according to an embodiment of the present invention may further include data analysis tools adapted to identify creation popularity trends and to provide business and marketing assistance. A calculator may be included to provide value rights based on performance, earnings and trends. This preferably would be a rights-valuation tool using multiple sources and may be based on previous sales or deals. The computer program product, system and method according to the present invention may further include showcase tools for both complete creations and part-creations seeking a partner for completion.

The present invention advantageously provides a management tool that can be used to compile a plurality of rights, metadata and data. The tool can be used to identify the original creators of the works that would be covered by the intellectual property rights. The tool can also advantageously be used to identify prospective identifying agents and licensees for the works protected by the intellectual property rights. The tool according to an embodiment of the present invention may further be used to compile related metadata to identify agents and licensees. The tool, according to an embodiment of the present invention, may further be used to link creators of works covered by the intellectual property rights to social networks. The tool may still further be used to facilitate multiple links between all sections of intellectual property rights management. Those skilled in the art will appreciate that the capabilities of the tools according to the present invention may also be carried out as a method according to the present invention.

The method of the present invention is not simply a routing dashboard. Many of the links being offered are original and offer a means to administer rights from a single point that have not been possible before. The method may also be presented as a ‘cloud’ option to be white-labeled or branded on behalf of any user as if it was his/her/its own system.

The computer program product, system and method according to the present invention advantageously allows a business user the ability to become a part of an end-to-end process that includes the original creator and all relevant interim parties. The user may be any party that could be seen to be a part of the wider network.

Additional details of the system and method according to the present invention are now described in greater detail. Composition details may be made available in a database for a user to view. The composition details may include details regarding the composer, i.e., picture and profile, details regarding the performer, i.e., picture and profile, as well as product details, i.e., date of creation, territory of recording (in whole or part), territory of mixing or production, release date, etc. Product details may also, for example, include information relating to audio details, artwork details and metadata details. This can also include links, or other types of connections, that use closed and open identifiers to any other relevant hierarchical information such as other compositions, or performances that include that party.

The computer program product, system and method according to an embodiment of the present invention may allow for users to connect, publish, collaborate, and engage in commerce with respect to works that they may create and that may be protected using intellectual property rights. The system may provide the composition details, performer details and product details, as described above. The system may also illustratively provide business details which may, for example, include information relating to opportunities, companies and businesses. The system allows for business persons and business entities, as well as artists, bands, and composers, to all connect with one another through various administrative contacts. The administrative contact may be a creative administrative contact as well as a business administrative contact. The system allows for all users to connect with one another for various opportunities, to do business with one another, to register copyrights, to license intellectual property, and to collaborate with other writers and artists.

A social networking aspect of the present invention is now described. The system may include a plurality of databases. The databases may, for example, include a works of art database, a composer database, a product database, and a contracts database. The system may include publishing administration as well as a social network in communication with the databases (or, as will be described below, a social networking interface) to thereby position all the databases in communication with one another. The system may allow various entities to communicate with one another, i.e., business persons, business entities, composers, artists, bands, etc., and may further include creative administrative contacts and business administrative contacts. Accordingly, the system allows for users to connect and collaborate, register their works of art, provide automated copyright registrations (or other intellectual property registrations as may be appropriate), and automated royalty reporting. As further illustrated in the appended drawings, by using the social networking aspect of the present invention, users may connect with one another, collaborate with one another, and publish new works or existing works, for public display. Of course, those skilled in the art will appreciate that the display of any works can be readily controlled by a user by using various administrative settings on the social networking aspect of the system according to the present invention. This aspect of the present invention advantageously provides to users that which has not been available in one single location, i.e., access to all that is or may be necessary to create, register, maintain, enhance, exploit, and otherwise profit from a work of art, or other intellectual property.

A dashboard feature according to the system and method of the present invention is now described in greater detail. The dashboard feature simply refers to the way in which information is displayed to users on a user interface using the system and method according to the present invention. The dashboard is for use by any user of the system and method including, but not limited to artists, composers, bands, business people, business entities, current licensees, prospective licensees, or any other person/entity that wishes to use the system and method according to the present invention. The dashboard provides various selections including, but not limited to, songs, composers, performers, products, contracts, reports, accounts, and networks. Accordingly, users can readily access various features of the system and method according to the present invention, or various databases included in the system and method according to the present invention, by selecting one or more of the corresponding buttons found on the dashboard.

In accordance with embodiments of the present invention, the components, process steps, and/or data structures may be implemented using various types of operating systems, computing platforms, computer programs, and/or general purpose machines. In addition, after having the benefit of this disclosure, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

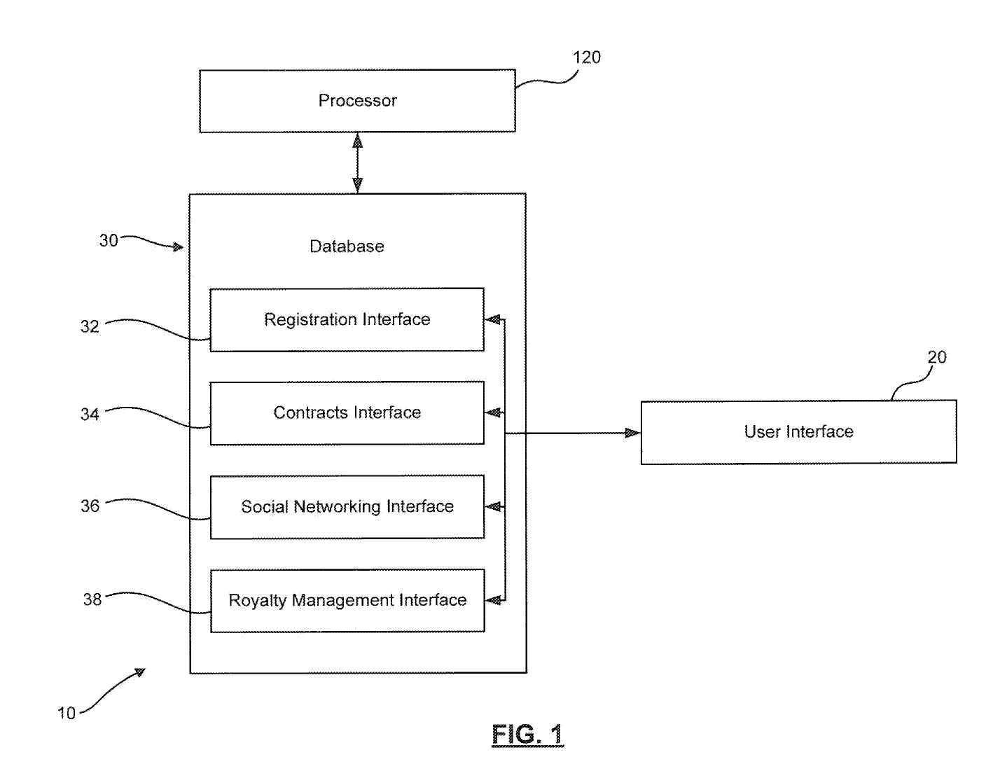

The system according to a preferred embodiment of the present invention may be provided by a computer program product 10 for managing intellectual property rights that requires the performance of one or more steps to be carried out on, or in association with, a computerized device. Referring now to the attached figures, additional details of the computer program product, system and method according to the present invention are now described in greater detail. Referring initially to FIG. 1, a schematic diagram illustrates that the computer program product 10 may comprise a user interface 20, a database 30 and a processor 120. The database 30 may include a registration interface 32, a contracts interface 34, a social network interface 36 and a royalty management interface 38. After having the benefit of this disclosure, those of ordinary skill in the art will recognize that the database 30 may be provided by a plurality of databases, links to external data sources, links to external databases, links to third party services, or links to a plurality of third party services, or the like, without departing from the scope and spirit of the inventive concepts disclosed herein. Third party services could be, for example, royalty management software, tax management software, audio management software or social network services external to the system. Those skilled in the art will further appreciate that third party services may be in communication with the computer program product according to an embodiment of the present invention through any number of mechanisms including, but not limited to a network interface, Bluetooth communication, or a cloud. A person of ordinary skill in the art will also appreciate that the computerized device may include, but not be limited to, a server, a computer (i.e., desktop computer, laptop computer, netbook, or any machine having a processor), a dumb terminal that provides an interface with a computer or server, a personal digital assistant, a mobile communications device, such as a mobile phone, smart phone or other similar device that provides computer or quasi-computer functionality, a mobile reader, such as an electronic document viewer, which provides reader functionality that may be enabled, through either internal components or connecting to an external computer, server, or global communications network (such as the Internet), to take direction from or engage in process which are then delivered to a mobile reader.

It should be readily apparent to those of ordinary skill in the art, after reviewing the materials disclosed herein, that other types of devices, individually or in conjunction with an overarching architecture, associated with an internal or external system, may be utilized to provide the “computerized” environment necessary for the process step to be carried out in a machine/system/digital environment. It should be noted that the method aspects of the present invention are preferably computer-implemented methods and, more particularly, at least one step is preferably carried out using a computerized device.

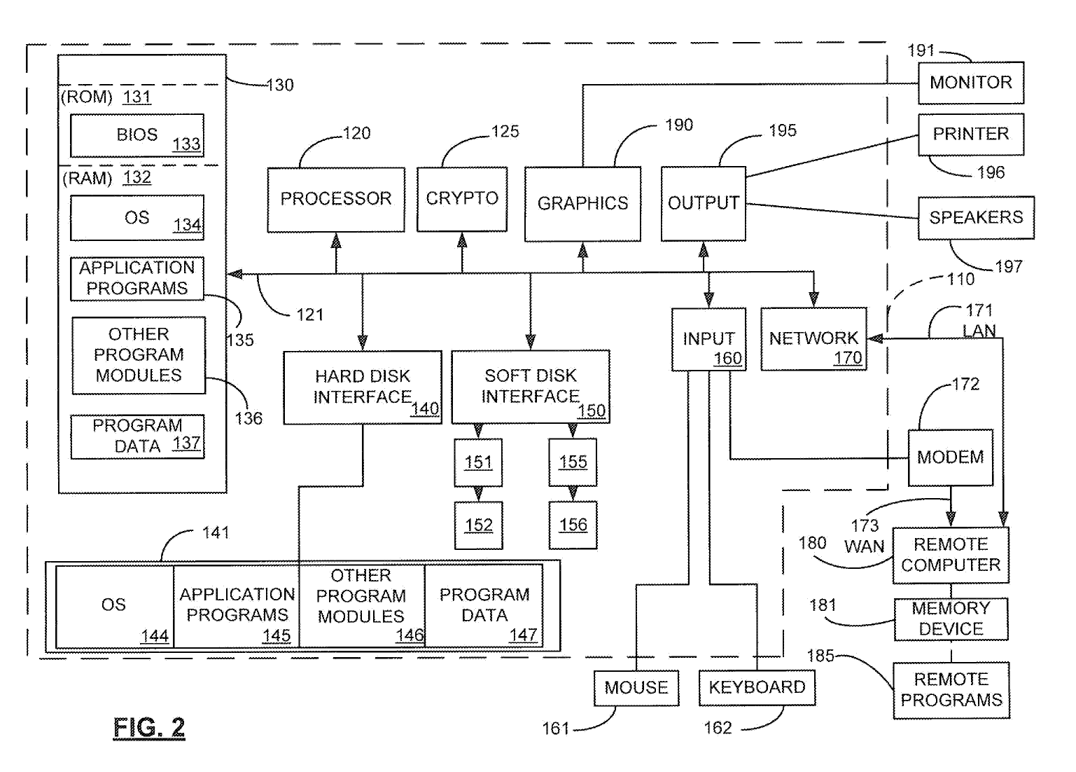

FIG. 2 illustrates a computing device in the form of a computer 110, which is capable of performing one or more computer-implemented steps in practicing the method aspects of the present invention. Components of the computer 110 may include, but are not limited to, the processor 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In other embodiments, the functions of the cryptographic unit may be instantiated in software and run via the operating system.

A computer 110 typically includes a variety of computer readable media. Computer readable media can be any available media that can be accessed by a computer 110 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates an operating system (OS) 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives, and their associated computer storage media discussed above and illustrated in FIG. 2, provide storage of computer readable instructions, data structures, program modules and other data for the computer 110. In FIG. 2, for example, hard disk drive 141 is illustrated as storing an OS 144, application programs 145, other program modules 146, and program data 147. Note that these components can either be the same as or different from OS 134, application programs 135, other program modules 136, and program data 137. The OS 144, application programs 145, other program modules 146, and program data 147 are given different numbers here to illustrate that, at a minimum, they may be different copies. A user may enter commands and information into the computer 110 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor 191, computers may also include other peripheral output devices such as speakers 197 and a printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 and 172 allow the device to communicate with other devices. The communications connections 170 and 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

According to an embodiment of the present invention, a computer program product 10 is disclosed, which may be capable of creating a computerized interface for use in data acquisition, establishing a database management system, and building an application based on the user data entered. A computer program product 10, according to an embodiment of the present invention, will be described in further detail as a project that is creatable using, for example, but not intended as a limitation, Microsoft's Visual C# .NET development environment. Such a computer program product 10 would be suitable for execution on a computer 110 having, for example, but not intended as a limitation, one of Microsoft's Windows family or Apple's Mac OSX family of operating systems loaded into memory 134. A person having ordinary skill in the art, after having the benefit of this disclosure would recognize that many other development platforms might be used to create a computer program product 10, which may be executable with many other operating systems, but that still embody the present invention. As such, the following disclosure is provided merely for explanatory purposes and should in no way limit the present invention to computer program products 10 that are created using the aforementioned development platform or for use with the aforementioned operating systems.

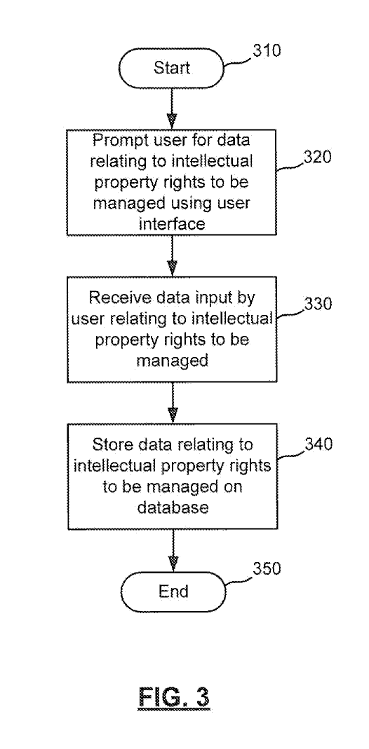

The user interface 20 may prompt a user for input of data relating to the intellectual property rights to be managed. The user interface 20 may prompt the user with an indication of a desire to exploit the intellectual property from another user or an indication that the intellectual property has been exploited by another user. FIG. 3 provides a basic overview of a method aspect according to an embodiment of the present invention directed to entering data relating to intellectual property rights to be managed using the user interface 20. From the start 310 the user may be prompted asking whether they wish to enter data 320 relating to intellectual property rights to be managed using the user interface. Data entered by the user may be received at Block 330 and then stored at Block 340 on the database 30. The method is ended at Block 350.

The database 30 may store the data relating to the intellectual property rights to be managed, and may include a registration interface 32, a contracts interface 34, a social networking interface 36, and a royalty management interface 37. The registration interface 32 may prompt the user for input of data relating to intellectual property rights to be managed for storage on the database. The intellectual property for which the intellectual property rights are to be managed may be uploadable using the registration interface 32. An application for registration of the intellectual property may be automatically filed with an appropriate authority upon uploading the intellectual property to the registration interface 32. For example, upon uploading the intellectual property to the database, the computer program product 10 according to an embodiment of the present invention may, after determining that the intellectual property has not been registered, automatically file an application for registration. Those skilled in the art will appreciate that this is only accomplished upon completing the steps associated with and necessary to complete an application for registration with an appropriate authority. For example, it may be necessary for the author/creator/assignor to execute certain documents associated with the application process. Similarly, there may be a requirement that a copy of the intellectual property be deposited with the appropriate registration authority. Accordingly, those skilled in the art will appreciate that the automation aspect of the registration interface of the computer program product 10, system and methods according to an embodiment of the present invention are only automated to a point, and automation of such a registration process is contemplated to the extent necessary to decrease the burden associated with such applications on the user.

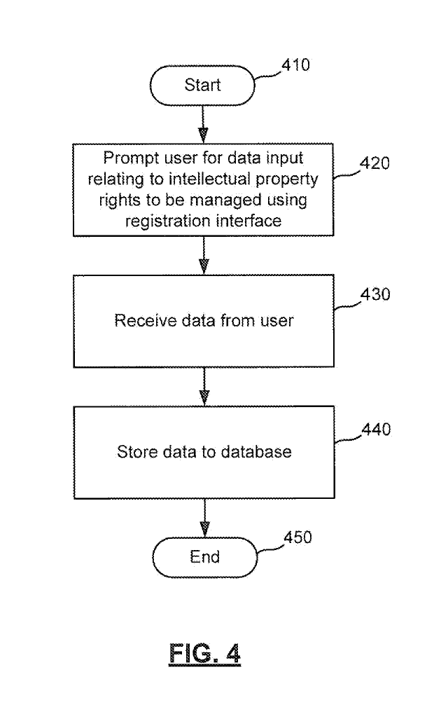

FIG. 4 provides a basic overview of another method aspect according to an embodiment of the present invention directed to entering data relating to intellectual property rights to be managed using the registration interface 32. From the start (Block 410) the user may be prompted for data input relating to the intellectual property rights to be managed using the registration interface at Block 420. Data entered by the user may be received at Block 430 and then stored to the database at Block 440. Thereafter the method is ended at Block 450.

The registration interface 32 may prompt the user for entry of information relating to whether or not the intellectual property for which the intellectual property rights are to be managed has been registered by an appropriate authority. Entry of information into the registration interface 32 indicating that the intellectual property has not been registered may result in the registration interface 32 prompting the user for an indication of whether or not the user desires the intellectual property to be registered. An indication that the user desires the intellectual property to be registered may result in the registration interface 32 prompting the user for information necessary to file an application for registration of the intellectual property with the appropriate authority. The registration interface 32 may monitor a registration for the intellectual property and may prompt the user for information necessary to maintain the registration. After having the benefit of this disclosure, those of ordinary skill in the art will appreciate that an appropriate authority can be a governmental agency, a performance rights organization, or the like, without departing from the scope and spirit of the inventive concepts disclosed herein.

After inputting the data using the registration interface 32, the user may be defined as a registered user. The registered user may be charged a subscription fee, a per service fee, or any other fee for use of the system. The registered user may be assigned an account that may be stored in the database 30. Royalties that may be collected from exploitation of the intellectual property may be automatically deposited into the account, or otherwise associated with the account. The present invention contemplates that each registered user may not literally be assigned an account suitable for the deposit of funds, but that the funds may be held in a general account and allocated appropriately to the registered user. Fees associated with management of the intellectual property may be automatically debited from the account of the registered user. Funds in the account of the registered user may be automatically depositable into an account external to the computer program product as designated by the registered user. This advantageously enhances the time within which a user may receive funds for the exploitation of their intellectual property, as well as enhance the time for which compensation may be paid for the administration of such services, if applicable. For example, the computer program product, system and methods according to the present invention may include creators of intellectual property and those who wish to create intellectual property. Upon identifying an article of intellectual property that one may wish to exploit, and upon exploiting the intellectual property, payment may automatically be made from one user's account to the account of another user. Upon the making of such a payment, the appropriate fee for the administration of the intellectual property rights may be automatically deducted.

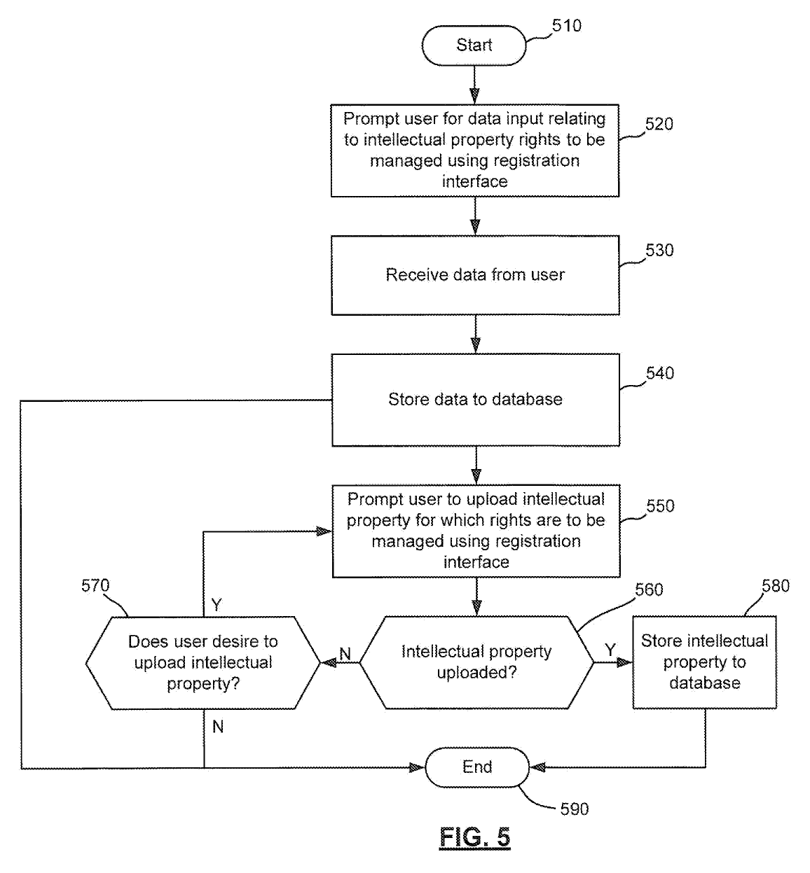

FIG. 5 provides a more detailed overview of a method aspect according to an embodiment of the present invention directed to entering data relating to intellectual property rights to be managed using the registration interface 32. From the start (Block 510) the user may be prompted for data input relating to intellectual property rights to be managed using the registration interface at Block 520. Data entered by the user may be received at Block 530 and then stored at Block 540 on the database 30. Thereafter, the method may optionally be ended at Block 590. The user may be prompted to upload intellectual property at Block 550. At Block 560, it may be determined whether the user uploaded intellectual property. If it is determined that the user did upload intellectual property at Block 560, the intellectual property may be stored at Block 580 to the database 30. If, however, it is determined that the user did not upload intellectual property at Block 560, the user may be prompted asking whether the user desires to upload intellectual property 570. If it is determined that the user desires to upload intellectual property at Block 570, the user may be prompted asking whether the user wishes to upload intellectual property at Block 550 and the method may proceed to completion. If, however, it is determined that the user does not desire to upload intellectual property at Block 570, the method according to an embodiment of the present invention may end at Block 590. After having the benefit of this disclosure, those of ordinary skill in the art will appreciate that uploading the intellectual property to the system may, for example, be automatically accomplished at the point of creation of the work by way of a link from a music software program, or a computer interface, or a mixing console, or a telecommunications device on which the work or recording may be created and stored. Once the intellectual property is uploaded and stored on the database 30, the user may choose to digitally distribute the intellectual property using the system or using a third party distributor.

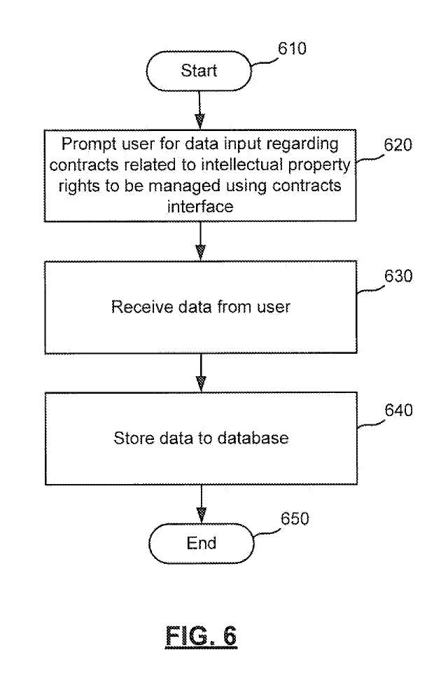

The contracts interface 34 may prompt the user for input of data regarding contracts related to the intellectual property rights to be managed for storage on the database. The contracts related to the intellectual property for which the intellectual property rights are to be managed may be uploadable using the contracts interface 34. In one embodiment of the computer program product 10 according to the present invention, the contracts stored on the database 30 may include a plurality of form agreements relating to exploitation of the intellectual property rights. The plurality of form agreements may be accessible, searchable, customizable, or usable by the user using the user interface. The plurality of form agreements may be selected from the group consisting of a licensing agreement, a collaboration agreement, a synchronization agreement, a public performance agreement, and a reproduction agreement. In another embodiment of the computer program product 10 according to the present invention, the contracts related to the intellectual property for which the intellectual property rights are to be managed may be uploadable using the user interface 20. FIG. 6 provides a basic overview of a method aspect according to an embodiment of the present invention directed to entering data regarding contracts relating to intellectual property rights to be managed using the contracts interface 34. From the start (Block 610) the user may be prompted to enter data at Block 620 relating to intellectual property rights to be managed using the contacts interface. This information may, for example, be directed to contracts that may have been entered into between the intellectual property creator and one who wishes to exploit the intellectual property, or may be information that may be necessary to complete a contract to exploit the intellectual property. In other words, the information that may be entered at Block 620 using the contracts interface may be any information related in any way to a contract relating to the intellectual property. Data entered by the user may be received at Block 630 and then stored at Block 640 on the database 30. Thereafter, the method is ended at Block 650.

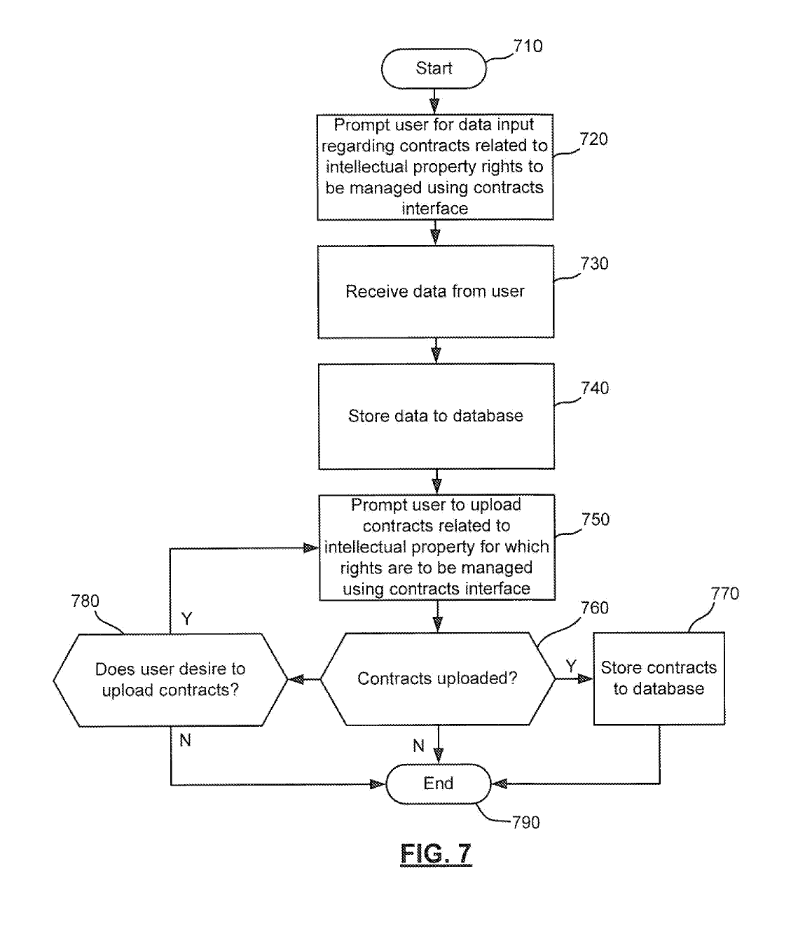

FIG. 7 provides a more detailed overview of a method aspect according to an embodiment of the present invention directed to entering data regarding contracts relating to intellectual property rights to be managed using the contracts interface 32. From the start (Block 710) the user may be prompted to enter the data at Block 720. Data entered by the user may be received at Block 730 and then stored at Block 740 on the database 30. The user may be prompted to upload contracts relating to intellectual property at Block 750. At Block 760, it may be determined whether the user uploaded contracts relating to intellectual property. If it is determined that the user did upload contracts relating to intellectual property at Block 760, the contracts relating to intellectual property may be stored at Block 770 to the database 30 and the method may be ended at Block 790. If, however, it is determined that the user did not upload contracts relating to intellectual property at Block 760, the user may be prompted asking whether the user desires to upload contracts relating to intellectual property 780. If it is determined that the user desires to upload contracts relating to the intellectual property at Block 780, the user may be prompted to upload contracts using the contracts interface at Block 750 and the method may proceed to completion. If, however, it is determined that the user does not desire to upload contracts relating to intellectual property at Block 780, the method according to an embodiment of the present invention may end at Block 790.

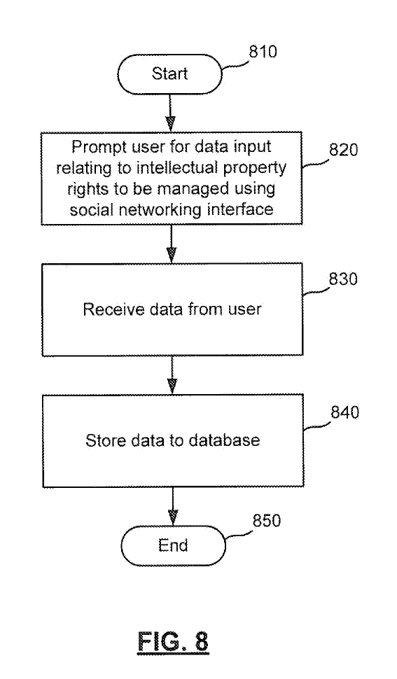

The social networking interface 36 may prompt the user for input of data relating to the intellectual property rights to be managed for storage on the database. The social networking interface 36 may provide access to members of a social network to at least a part of the intellectual property. FIG. 8 is a flowchart that provides a basic overview of a method according to an embodiment of the present invention directed to entering data relating to intellectual property rights to be managed using the social networking interface 36. From the start (Block 810) the user may be prompted asking whether they wish to enter data at Block 820 using the social networking interface. Data entered by the user may be received at Block 830 and then stored at Block 840 on the database 30. The method may be ended at Block 850.

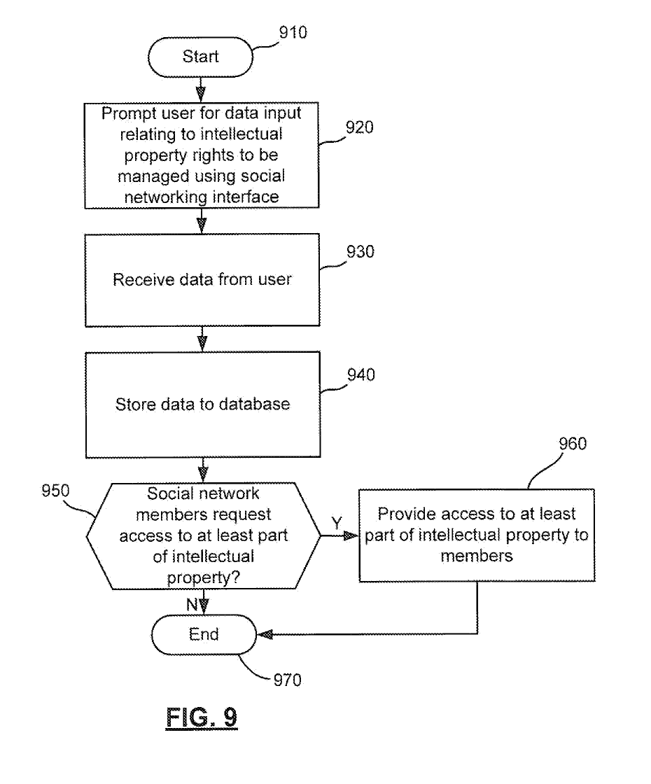

FIG. 9 provides a flowchart illustrating a more detailed overview of a method aspect according to an embodiment of the present invention directed to entering data relating to intellectual property rights to be managed using the social networking interface 36. From the start (Block 910) the user may be prompted asking whether they wish to enter data at Block 920. Data entered by the user may be received at Block 930 and then stored at Block 940 on the database 30. At Block 950, it may be determined whether a social network member requests access to at least part of the intellectual property. If it is determined that the social network member did request access to at least part of the intellectual property at Block 950, the social network interface may provide access to at least part of the intellectual property to the social network member at Block 960. If, however, it is determined that the social network member did not request access to at least part of the intellectual property at Block 950, the method according to an embodiment of the present invention may end at Block 970.

Those skilled in the art will appreciate that the social network interface advantageously allows a user to harness the volume of potential people that may have some sort of an interest in the intellectual property. More specifically, the computer program product and methods according to embodiments of the present invention advantageously allows a content creator, i.e., owner of the intellectual property rights, to readily expose the intellectual property to be exploited to the several people that use social networking. The present invention advantageously contemplates that an interface may be provided to several different social networking sites wherein the intellectual property may be displayed for promotional purposes, for example. More particularly, and for exemplary purposes, after uploading the intellectual property to the database, the user may desire to provide exposure to the intellectual property by posting the intellectual property using various social media. This can be accomplished from using the same computer program product. Accordingly, the computer program product and methods according to the present invention advantageously allows for the intellectual property rights to be managed to be readily displayed, and the exploitation of the intellectual property to be readily monitored so that royalties from the intellectual property can be readily collected and distributed. Providing a social networking interface is merely one additional tool that provides the user with enhanced exposure to the intellectual property that has not otherwise been available.

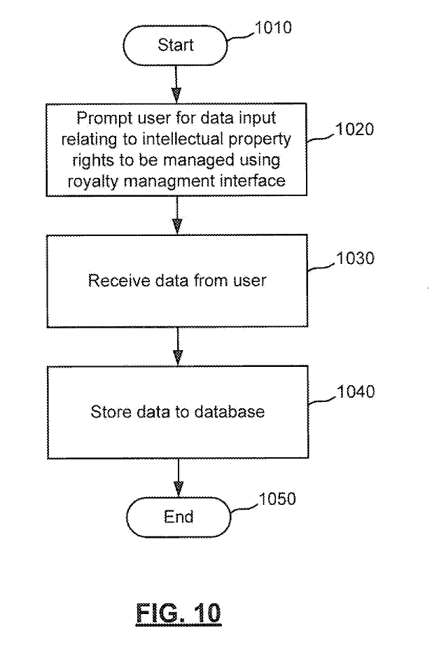

The royalty management interface 38 may prompt the user for input of data relating to the intellectual property rights to be managed for storage on the database. The royalty management interface 38 may permit the user to manage royalties relating to the intellectual property. The user, after inputting the data using the registration interface 32, may be defined as a registered user. The registered user may be assigned an account that is stored in the database 30. Royalties may be collected from exploitation of the intellectual property and may be automatically deposited into the account. Fees associated with management of the intellectual property may be automatically debited from the account of the registered user. Funds in the account of the registered user may be automatically depositable into an account external to the computer program product 10 as designated by the registered user. The flowchart of FIG. 10 provides a basic overview of a method aspect according to an embodiment of the present invention directed to entering data relating to intellectual property rights to be managed using the royalty management interface 36. From the start (Block 1010) the user may be prompted asking whether they wish to enter data at Block 1020. Data entered by the user may be received at Block 1030 and then stored at Block 1040 on the database 30. Thereafter, the method may be ended at Block 1050.

Those skilled in the art will appreciate that the information that may be requested of the user to complete registration using the registration interface may be any type of information. For example, it is contemplated that the user will be prompted with certain contact information, as well as be prompted to provide information relating to the intellectual property for which the intellectual property rights are to be managed. Certain information may be verifiable in order to ensure that the user can be properly registered. Such information may be stored for a period of time on the database. It is contemplated that user information may be stored indefinitely, or for some period of time after the registered user ceases using the computer program product and methods according to the present invention.

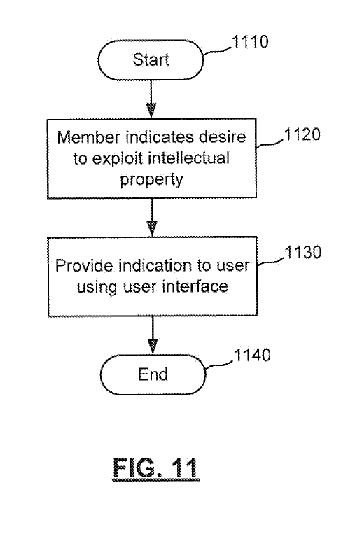

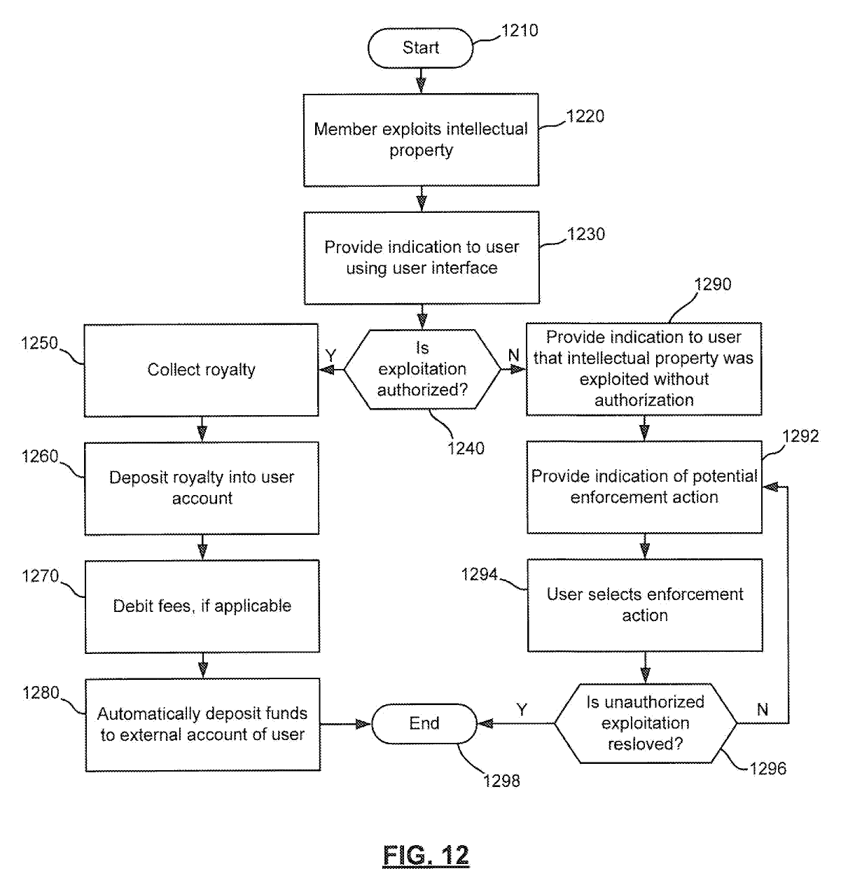

The flowchart of FIG. 11 provides a basic overview of a method aspect according to an embodiment of the present invention directed to exploitation of the intellectual property. From the start (Block 1110) a member may indicate a desire to exploit the intellectual property at Block 1120. The user may be prompted with an indication that a member desires to exploit the intellectual property at Block 1130. The method may thereafter be ended at Block 1140. The flowchart illustrated in FIG. 12 provides a more detailed overview of a method according to an embodiment of the present invention directed to exploiting the intellectual property. From the start (Block 1210) the member may indicate a desire to exploit the intellectual property at Block 1220. The user may be prompted with an indication that a member desires to exploit the intellectual property at Block 1230. At Block 1240, it may be determined whether the exploitation of the intellectual property is authorized. If it is determined that the exploitation of the intellectual property is authorized at Block 1240, a royalty may be collected at Block 1250. The royalty collected may be deposited into a user account at Block 1260 and fees may be debited from the user account at Block 1270. Funds may be deposited to an external account of the user 1280, and the method may be ended at Block 1298. If it is determined that the exploitation of the intellectual property is not authorized at Block 1240, an indication can be provided to the user that the exploitation of the intellectual property was not authorized at Block 1290. An indication of potential enforcement action may be provided to the user at Block 1292. The user may select an enforcement action at Block 1294. At Block 1296, it can be determined whether authorization of the exploitation of the intellectual property has been resolved. If it is determined at Block 1296 that authorization of exploitation of the intellectual property has not been resolved, the user may again be provided with an indication of potential enforcement action at Block 1292. If it is determined at Block 1296 that authorization of the exploitation of the intellectual property has been resolved, the method according to an embodiment of the present invention may end at Block 1298.

Those skilled in the art will appreciate that enforcement of the intellectual property rights may take many forms. For example, it is contemplated that such enforcement may include sending a request to the unauthorized user to cease and desist from further unauthorized use of the intellectual property. The enforcement may also be referring the intellectual property owner and the unauthorized user to alternative dispute resolution in an attempt to resolve the unauthorized use. Further, it is contemplated that the enforcement action may include referral of the intellectual property owner to an attorney to take further enforcement action. It is contemplated that the database may include information relating to outside resources that may be available to users to enforce their intellectual property rights against unauthorized use. The database may include names and addresses of attorneys which may be sorted in any number of ways, i.e., geographical location, intellectual property specialty, etc.

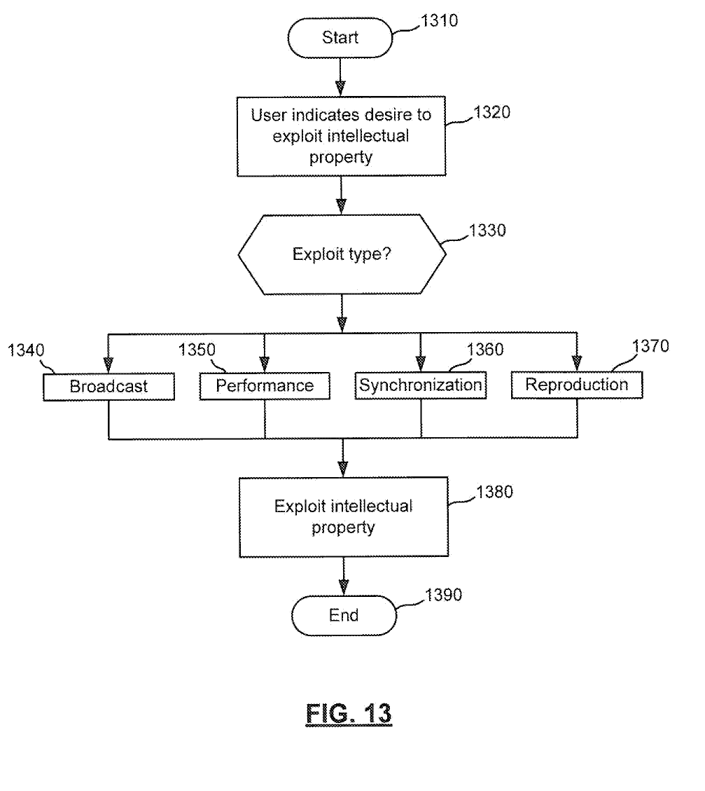

The flowchart of FIG. 13 provides a more detailed overview of a method aspect according to an embodiment of the present invention directed to exploiting the intellectual property. From the start (Block 1310) the member may indicate a desire to exploit the intellectual property at Block 1320. At Block 1330, the user may be prompted to select the type of exploitation of the intellectual property. The user may select to broadcast the intellectual property at Block 1340, perform the intellectual property at Block 1350, synchronize the intellectual property at Block 1360, or reproduce the intellectual property at Block 1370. After selecting the type of exploitation of the intellectual property, the user may exploit the intellectual property at Block 1380. The method is ended at Block 1390.

Those skilled in the art will appreciate that exploitation of the intellectual property is meant to be broadly interpreted. For example, it is contemplated that the type of intellectual property to be exploited may be related to copyrights or music. Accordingly, the present invention contemplates that the exploitation may, for example, be reproduction of music, broadcasting the music, performance of the music, or synchronization of the music. The present invention also contemplates that the type of intellectual property to be exploited may, for example, be an invention as embodied in a patent. In such a case, the exploitation of such a patent right may be making, using, selling, or offering to sell the invention as outlined in the patent. Similarly, the present invention contemplates that the type of intellectual property right to be exploited may be a trademark. In such a case, it is contemplated that the present invention will assist the trademark owner in licensing a trademark for use in connection with appropriate goods and services. The present invention can also advantageously be used when exploiting intellectual property rights related to certain franchises or with respect to franchise rights in general. Those skilled in the art will appreciate that several different types of intellectual property rights are contemplated by the present invention.

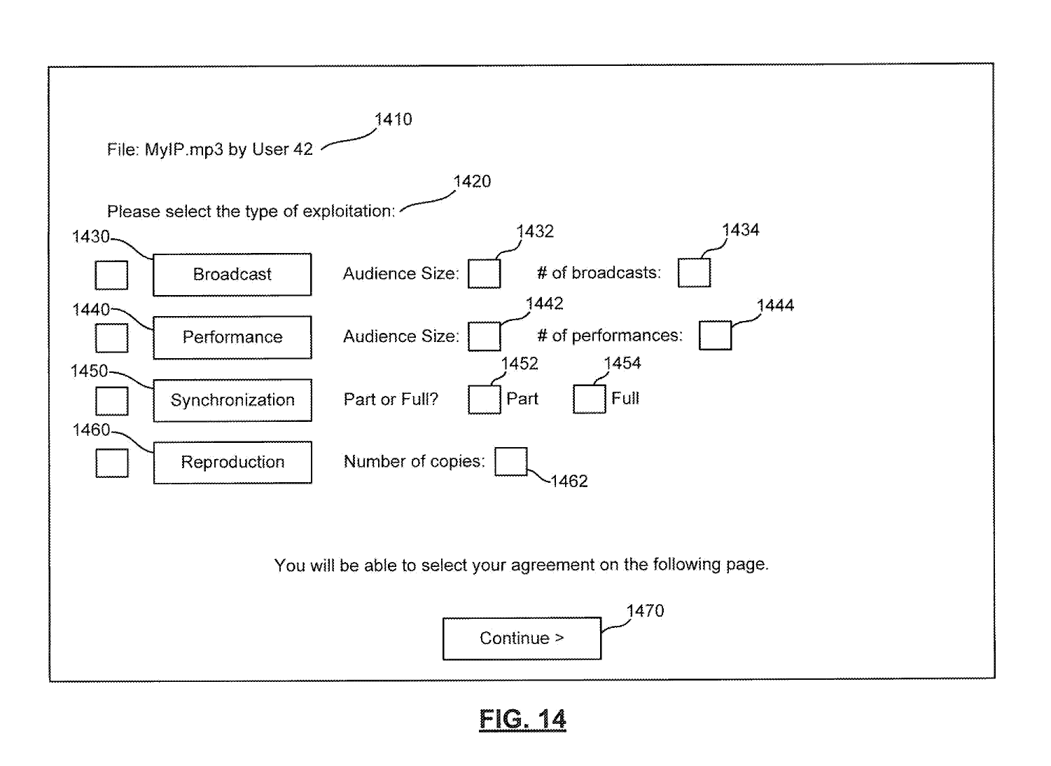

FIG. 14 provides a more detailed overview of a dashboard feature according to the computer program product, system and method of the present invention. The dashboard feature refers to the way in which information may be displayed to users on a user interface using the system and method according to the present invention. The dashboard may provide various selections including, but not limited to, the intellectual property to be exploited 1410, and the type of exploitation 1420. The type of exploitation may include broadcast 1430, performance 1440, synchronization 1450 and reproduction 1460. Selection of the option to broadcast the intellectual property may include input of the size of the audience 1432, and may include the number of broadcasts 1434. Selection of the option to perform the intellectual property may include input of the size of the audience 1442, and may include the number of performances 1444. Selection of the option to synchronize the intellectual property may include the option to synchronize part of the intellectual property 1452 or synchronize all of the intellectual property 1454. Selection of the option to reproduce the intellectual property may include the option to input the number of copies of the intellectual property 1462. The dashboard feature according to an embodiment of the present invention may include an option to view a next page 1470.

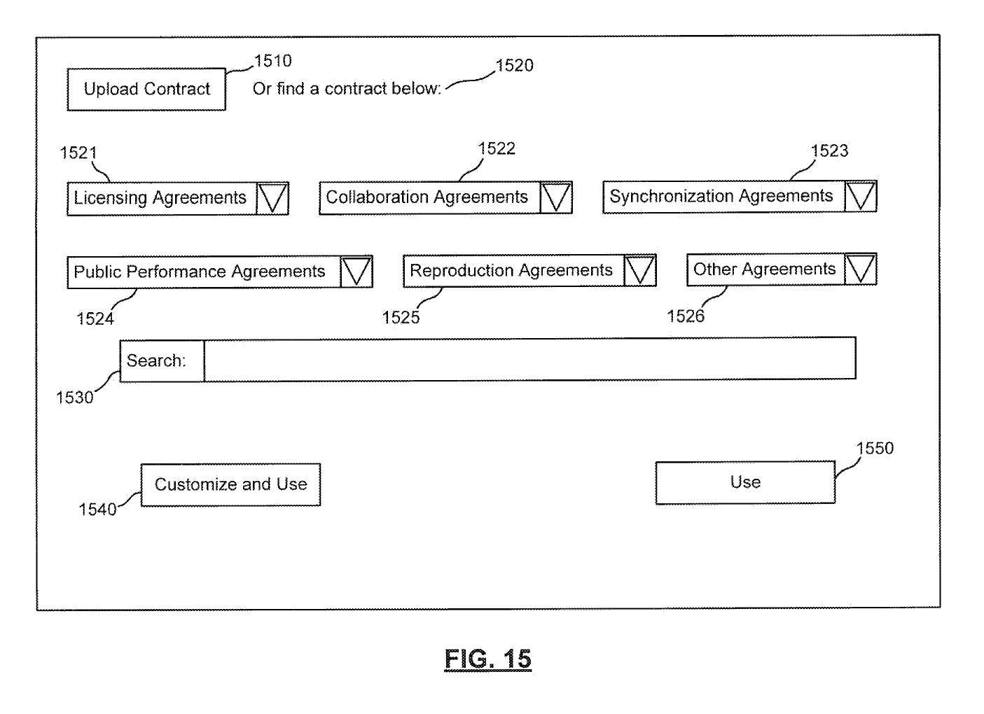

FIG. 15 provides a more detailed overview of a dashboard feature according to the system and method of the present invention. The dashboard may provide various selections including, but not limited to, uploading a contract 1510, selecting a contract 1520, searching for a contract 1530, customizing a contract 1540, and using a contract 1550. Choosing the option to select a contract may include selecting a licensing agreement 1521, selecting a collaboration agreement 1522, selecting a synchronization agreement 1523, selecting a public performance agreement 1524, selecting a reproduction agreement 1525, and selecting other agreements 1526. Accordingly, users can readily access various features of the system and method according to the present invention, or various databases included in the system and method according to the present invention, by selecting one or more of the corresponding buttons found on the dashboard.

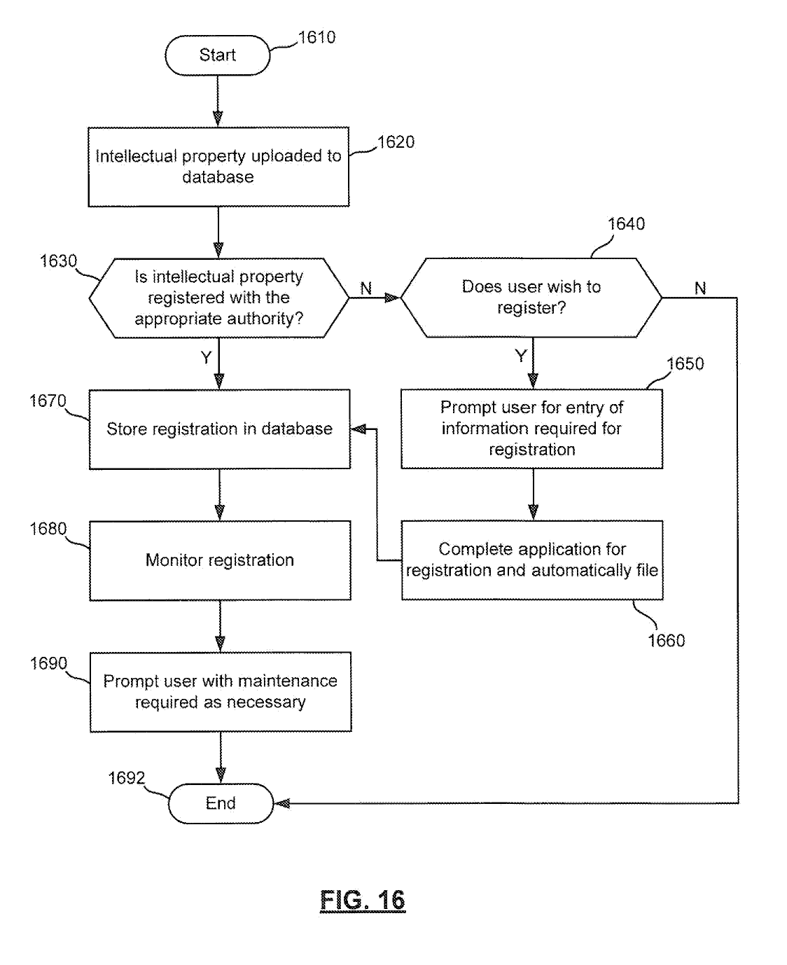

The flowchart illustrated in FIG. 16 provides a more detailed overview of a method aspect according to an embodiment of the present invention directed to registration of the intellectual property with an appropriate authority. From the start (Block 1610) the user may upload the intellectual property at Block 1620 to the database 30. At Block 1630, it may be determined whether the intellectual property has been registered with an appropriate authority. If it is determined that the intellectual property has not been registered with an appropriate authority at Block 1630, the user may be prompted asking whether the user desires to register the intellectual property with the appropriate authority at Block 1640. If it is determined at Block 1640 that the user desires to register the intellectual property, the user may be prompted for entry of data required for registration of the intellectual property at Block 1650. The user may complete application for registration and automatically register the intellectual property at Block 1660. The registration may be stored at Block 1670 in the database 30 and the registration may be monitored at Block 1680. The user may be prompted as necessary when action is required to maintain the registration at Block 1690. If it is determined at Block 1630 that the intellectual property is registered with the appropriate authority, the registration may be stored at Block 1670 and the method may proceed to completion. If it is determined at Block 1640 that the user does not desire to register the intellectual property with an appropriate authority, the method according to an embodiment of the present invention may end at Block 1692.

As described in greater detail above, although the present invention contemplates automatic registration of the intellectual property with an appropriate authority, those skilled in the art will appreciate that the automation of such registration is limited to the type of application that must be filed. For example, with respect to copyright registration, the user may be prompted to enter the information necessary to complete the application, but the application would not be automatically filed until the user approves and execute the application. Similarly, in the case of a trademark application, such an application would not be filed until the owner of the intellectual property rights to be managed has signed the appropriate declarations that may be necessary to complete such an application. Although the present invention contemplate that forms relating to filing of a patent application may be created using the computer program product, system and methods according to the present invention, the actual drafting of a patent application requires a great deal of language that is specific to each different invention and, as such, is likely not available as a “form” that would be suitable for automatic registration. This feature of the present invention, however, does advantageously maintain the intellectual property and, as such, relieves the user of the burden associated with tracking the several dates necessary to maintain various types of intellectual property over time.

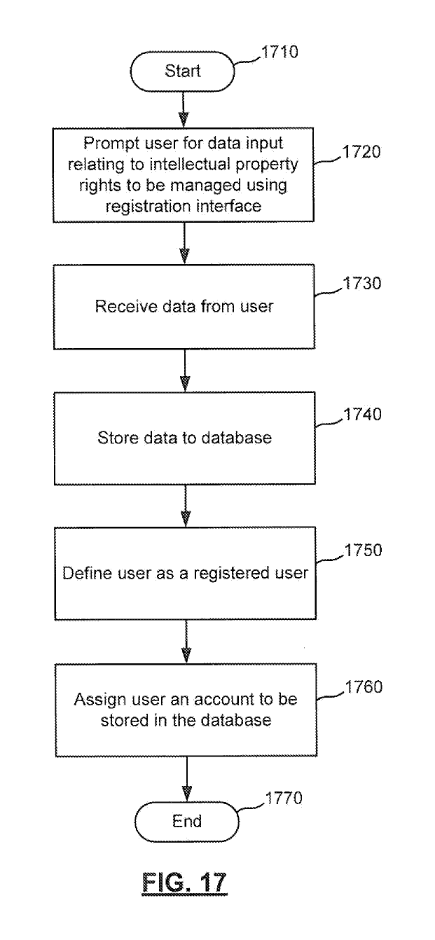

The flowchart illustrated in FIG. 17 provides a basic overview of a method aspect according to an embodiment of the present invention directed to entering data relating to intellectual property rights using the registration interface. From the start (Block 1710) the user may be prompted to enter data relating to the intellectual property rights to be managed at Block 1720. Data may be received from the user at Block 1730 and stored at Block 1740 on the database 30. The user may be defined as a registered user at Block 1750 and may be assigned an account at Block 1760 to be stored on the database 30. The method is thereafter ended at Block 1770.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

That which is claimed is:

1. A computer program product for managing intellectual property rights, the computer program product comprising:
a user interface that prompts a user for input of data relating to the intellectual property rights to be managed; and
a database to store the data relating to the intellectual property rights to be managed, the database comprising
a registration interface to prompt the user for input of data relating to the intellectual property rights to be managed for storage on the database, wherein the intellectual property for which the intellectual property rights are to be managed is uploadable using the registration interface;
a contracts interface to prompt the user for input of data regarding contracts related to the intellectual property rights to be managed for storage on the database, wherein the contracts related to the intellectual property for which the intellectual property rights are to be managed are uploadable using the contracts interface;
a social networking interface which prompts the user for input of data relating to the intellectual property rights to be managed for storage on the database, wherein the social networking interface provides access to members of a social network to at least a part of the intellectual property; and
a royalty management interface which prompts the user for input of data relating to the intellectual property rights to be managed for storage on the database, wherein the royalty management interface permits the user to manage royalties relating to the intellectual property;
wherein the user is prompted with an indication of a desire to exploit the intellectual property from another user or an indication that the intellectual property has been exploited by another user using the user interface; and
wherein the computer program product uses a processor that executes instructions to prompt the user for data, to store data, to provide access to the social network, to manage royalties, to indicate the desire to exploit the intellectual property and to indicate the intellectual property has been exploited.

2. A computer program product according to claim 1 wherein exploitation of the intellectual property is selected from the group consisting of broadcast of the intellectual property, performance of the intellectual property, synchronization of the intellectual property, and reproduction of the intellectual property in whole or in part.

3. A computer program product according to claim 1 wherein the contracts stored on the database includes a plurality of form agreements relating to the exploitation of the intellectual property rights that are accessible, searchable, customizable, or usable by the user using the user interface.

4. A computer program product according to claim 3 wherein the plurality of form agreements are selected from the group consisting of a licensing agreement, a collaboration agreement, a synchronization agreement, a public performance agreement, and a reproduction agreement.

5. A computer program product according to claim 1 wherein a contract entered into by the user is uploadable to the contracts database using the user interface.

6. A computer program product according to claim 1 wherein an application for registration of the intellectual property is automatically filed with an appropriate authority upon uploading the intellectual property to the registration interface.

7. A computer program product according to claim 1 wherein the registration interface prompts the user for entry of information relating to whether or not the intellectual property for which the intellectual property rights are to be managed has been registered by an appropriate authority; wherein entry of information indicating that the intellectual property has not been registered results in the registration interface prompting the user for an indication of whether or not the user desires the intellectual property to be registered; and wherein an indication that the user desires the intellectual property to be registered results in the registration interface prompting the user for information necessary to file an application for registration of the intellectual property with the appropriate authority.

8. A computer program product according to claim 1 wherein the registration interface monitors a registration for the intellectual property and prompts the user for information necessary to maintain the registration.

9. A computer program product according to claim 1 wherein the user, after inputting the data using the registration interface, is defined as a registered user; wherein the registered user is assigned an account that is stored in the database; and wherein royalties that are collected from exploitation of the intellectual property are automatically deposited into the account.

10. A computer program product according to claim 9 wherein fees associated with management of the intellectual property are automatically debited from the account of the registered user.

11. A computer program product according to claim 9 wherein funds in the account of the registered user are automatically depositable into an account external to the computer program product as designated by the registered user.

12. A method for managing intellectual property rights using a computer program product, the computer program product comprising a user interface and a database, the method comprising:
entering data relating to intellectual property rights to be managed using the user interface responsive to a prompt; and
storing the data on the database, wherein storing the data comprises:
entering data using a registration interface responsive to a prompt to the user for input of the data relating to the intellectual property rights to be managed, wherein the intellectual property is uploadable using the registration interface;
entering data using a contracts interface responsive to a prompt to the user for input of the data regarding contracts related to the intellectual property rights to be managed for storage on the database, wherein the contracts related to the intellectual property are uploadable using the contracts interface;
entering data using a social networking interface responsive to a prompt to the user for input of the data relating to the intellectual property rights to be managed for storage on the database, wherein the social networking interface provides access to members of a social network to at least a part of the intellectual property;
entering data using a royalty management interface responsive to a prompt to the user for input of the data relating to the intellectual property rights to be managed for storage on the database, wherein the royalty management interface permits the user to manage royalties relating to the intellectual property; and
responding to a prompt from the user interface that indicates a desire to exploit the intellectual property from another user or that indicates that the intellectual property has been exploited by another user.

13. A method according to claim 12 further comprising exploiting the intellectual property, wherein exploiting the intellectual property is selected from the group consisting of broadcasting the intellectual property, performing the intellectual property, synchronizing the intellectual property, and reproducing the intellectual property in whole or in part.

14. A method according to claim 12 further comprising using the user interface to access, search, customize, or use the contracts stored on the database, wherein the contracts stored on the database include a plurality of form agreements relating to the exploitation of the intellectual property rights that are accessible, searchable, customizable, or usable by the user using the user interface.

15. A method according to claim 14 wherein the plurality of form agreements are selected from the group consisting of a licensing agreement, a collaboration agreement, a synchronization agreement, a public performance agreement, and a reproduction agreement.

16. A method according to claim 12 further comprising uploading a contract entered into by the user to the contracts stored on the database using the user interface.

17. A method according to claim 12 further comprising automatically filing an application for registration of the intellectual property with an appropriate authority upon uploading the intellectual property to the registration interface.

18. A method according to claim 12 further comprising entering information relating to whether or not the intellectual property has been registered by an appropriate authority, wherein the registration interface prompts a user for entry of information relating to whether or not the intellectual property has been registered by an appropriate authority; wherein entry of information indicating that the intellectual property has not been registered results in the registration interface prompting the user for an indication of whether or not the user desires the intellectual property to be registered; and wherein an indication that the user desires the intellectual property to be registered results in the registration interface prompting the user for information necessary to file an application for registration of the intellectual property with the appropriate authority.

19. A method according to claim 12 further comprising entering information necessary to maintain the registration for the intellectual property using the user interface, wherein the registration interface monitors a registration for the intellectual property and prompts the user for information necessary to maintain the registration.

20. A method according to claim 12 further comprising collecting royalties from exploitation of the intellectual property, wherein the user, after inputting data using the registration interface, is defined as a registered user; wherein the registered user is assigned an account that is stored in the database; and wherein royalties that are collected from exploitation of the intellectual property are automatically deposited into the account.

21. A method according to claim 20 further comprising automatically debiting fees associated with management of the intellectual property from the account of the registered user.

22. A method according to claim 20 further comprising automatically depositing funds from the account of the registered user into an account external to the computer program product as designated by the registered user.

23. A method for managing intellectual property rights using a computer program product, the computer program product comprising a user interface and a database, the method comprising:
entering data relating to intellectual property rights to be managed using the user interface responsive to a prompt;
storing the data on the database, wherein the database is searchable based upon criteria selected by the user and wherein storing the data comprises:
entering data using a registration interface responsive to a prompt to the user for input of the data relating to the intellectual property rights to be managed, wherein the intellectual property is uploadable using the registration interface;
entering data using a contracts interface responsive to a prompt to the user for input of the data regarding contracts related to the intellectual property rights to be managed for storage on the database, wherein the contracts related to the intellectual property are uploadable using the contracts interface;
entering data using a social networking interface responsive to a prompt to the user for input of the data relating to the intellectual property rights to be managed for storage on the database, wherein the social networking interface provides access to members of a social network to at least a part of the intellectual property;
entering data using a royalty management interface responsive to a prompt to the user for input of the data relating to the intellectual property rights to be managed for storage on the database, wherein the royalty management interface permits the user to manage royalties relating to the intellectual property; and
responding to a prompt from the user interface that indicates a desire to exploit the intellectual property from another user or that indicates that the intellectual property has been exploited by another user;
collecting royalties from exploitation of the intellectual property, wherein the user, after inputting data using the registration interface, is defined as a registered user; wherein the registered user is assigned an account that is stored in the database; and wherein royalties that are collected from exploitation of the intellectual property are automatically deposited into the account;
debiting fees associated with management of the intellectual property from the account of the registered user; and
depositing funds from the account of the registered user into an account external to the computer program product as designated by the registered user.

24. A method according to claim 23 further comprising exploiting the intellectual property, wherein exploiting the intellectual property is selected from the group consisting of broadcasting the intellectual property, performing the intellectual property, synchronizing the intellectual property, and reproducing the intellectual property in whole or in part.

25. A method according to claim 23 wherein exploitation of the intellectual property by another user is defined as an authorized exploitation or an unauthorized exploitation; and further comprising sending an instruction to take enforcement action against an unauthorized exploitation of the intellectual property.

26. A method according to claim 23 further comprising using the user interface to access, search, customize, or use the contracts stored on the database, wherein the contracts stored on the database include a plurality of form agreements relating to the exploitation of the intellectual property rights that are accessible, searchable, customizable, or usable by the user using the user interface.

27. A method according to claim 26 wherein the plurality of form agreements are selected from the group consisting of a licensing agreement, a collaboration agreement, a synchronization agreement, a public performance agreement, and a reproduction agreement.

28. A method according to claim 23 further comprising uploading a contract entered into by the user to the contracts stored on the database using the user interface.

29. A method according to claim 23 further comprising automatically filing an application for registration of the intellectual property with an appropriate authority upon uploading the intellectual property to the registration interface.

30. A method according to claim 23 further comprising entering information relating to whether or not the intellectual property has been registered by an appropriate authority, wherein the registration interface prompts a user for entry of information relating to whether or not the intellectual property has been registered by an appropriate authority; wherein entry of information indicating that the intellectual property has not been registered results in the registration interface prompting the user for an indication of whether or not the user desires the intellectual property to be registered; and wherein an indication that the user desires the intellectual property to be registered results in the registration interface prompting the user for information necessary to file an application for registration of the intellectual property with the appropriate authority.

31. A method according to claim 23 further comprising entering information necessary to maintain the registration for the intellectual property using the user interface, wherein the registration interface monitors a registration for the intellectual property and prompts the user for information necessary to maintain the registration.

32. A method according to claim 23 wherein the fees associated with management of the intellectual property are automatically debited from the account of the registered user; and wherein funds deposited from the account of the registered user into an account external to the computer program product designated by the registered user are automatically deposited.
